(19) United States
(12) Patent Application Publication
(10) Pub. No.: US 2019/0066116 A1
(43) Pub. Date: Feb. 28, 2019

(54) SYSTEM AND METHOD FOR ORGANIZING AND INTEGRATING ELECTRONIC CUSTOMER SERVICE RESOURCES

(71) Applicant: Verint Americas Inc., Alpharetta, GA (US)

(72) Inventor: Scott Mackie, Glasgow (GB)

(73) Assignee: Verint Americas Inc., Alpharetta, GA (US)

(21) Appl. No.: 15/689,968

(22) Filed: Aug. 29, 2017

(51) Int. Cl. G06Q 30/00; G06F 17/30

(52) U.S. Cl. CPC G06Q 30/016; G06F 17/30011

(57) ABSTRACT

The present invention is a system and method for organizing and integrating electronic customer service resources. A CEC system from a customer interaction receives data from a customer interaction and analyzes the data using a CAE incorporating a set of analytics rules before selecting a customer service module or a document from a document database based on the analysis. This data analysis and module or document selection repeats until all data received by the CEC system has been analyzed.

### FIELD

The present disclosure is directed to a method for computer analysis, specifically a method of organizing and integrating electronic customer service resources for a user.

### BACKGROUND

In a modern high-volume customer engagement center (CEC), it is often the case that a customer contact or communication requires a wide variety of communication protocols and resources. Computerized scripts provide predetermined optimized dialogue, desktop help screens provide information outside of normal channels, quality assurance computer systems provide real-time monitoring of the quality of a customer service representative's (CSR's) interaction with customers, software routing engines direct communications to appropriate CSRs, and so forth. Many CSRs become adept over time at utilizing every computer resource available to them to increase communication efficiency and customer satisfaction.

It is often the case, however, that when a new computer protocol or resource becomes available in a CEC computer system, the CSR may initially be unfamiliar with how to best integrate it into their customer service routine. A new computer protocol or resource may have a synergistic effect when used another computer protocol or resource, but be useless or even detrimental without combination of the functions. Furthermore, a new CSR begins without any familiarity with the myriad computer resources available to them in the CEC computer system. As a result, they may use these resources inefficiently or completely miss vital computer protocol and resources. Moreover, CSRs with inherently poor communication skills require additional assistance when interacting with customers. Any of the above scenarios may lead to delay, missed or improper communications, decreased efficiency, or increased customer dissatisfaction.

For example, a CSR assigned to communicate with a high-value customer may mistakenly use an old communication protocol still stored in the CEC computer system as opposed to a new protocol designed to take into account the customer's new preferences. By the time the CSR realizes their mistake, the customer relationship may be damaged. In another example, a new CSR may receive an email because it was flagged for potential fraudulent activity, but not know how to access a routing log listing why the email was flagged. This CSR is required to undertake time-consuming research and review, potentially delaying a transaction that was not fraudulent, but had still triggered an automatic fraud review protocol. In another example, a CSR may need to access multiple computer resources for telephone contacts, delaying the call until they are able to locate and assemble all the resources they need. This may not be feasible for incoming calls with an impatient customer.

There is an unmet need in the art for a system and method capable of automatically providing computer-based communication resources to a CSR. There is a further unmet need in the art for a system and method capable of integrating and presenting these resources as needed in a complimentary fashion.

### SUMMARY

An exemplary embodiment of the present application is a method for organizing and integrating electronic customer service resources. A CEC system from a customer interaction receives data from a customer interaction and analyzes the data using a central analytics engine (CAE) incorporating a set of analytics rules before selecting at least one customer service module or at least one document from at least one document database based on the analysis. This data analysis and customer service module or document selection is repeated until all data received by the CEC system has been analyzed.

Another exemplary embodiment of the present application is a system for organizing and integrating electronic customer service resources. The system includes a processor and a non-transient computer readable medium programmed with computer readable code that upon execution by the processor causes the processor to execute the above-mentioned method for organizing and integrating electronic customer service resources.

Another exemplary embodiment of the present application is a non-transient computer readable medium programmed with computer readable code that upon execution by a processor causes the processor to execute the above-mentioned method for organizing and integrating electronic customer service resources.

The objects and advantages will appear more fully from the following detailed description made in conjunction with the accompanying drawings.

### BRIEF DESCRIPTION OF THE DRAWING(S)

FIG. 1 depicts an exemplary embodiment of a CEC system for organizing and integrating electronic customer service resources.

FIGS. 2a and 2b depict a flowchart of an exemplary embodiment of a method for organizing and integrating electronic customer service resources.

FIG. 3 depicts an exemplary embodiment of a system for organizing and integrating electronic customer service resources.

### DETAILED DESCRIPTION OF THE DRAWING(S)

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

CEC systems allow CSRs to engage with customers in a controlled manner. By providing organized and integrated computer-based customer service resources, the CEC system can allow an organization to achieve several key benefits. First, the system will ensure maximized use of the appropriate resources with minimal CSR training. Second, the CEC system's adaptive nature allows it to adjust to new protocols and individual CSR habits and preferences. Third, the CEC system's interlinked and adaptive nature allows it to adjust to wide-scale organizational habits and preferences developed over time, and to provide accurate feedback for evaluation of the use of available resources. Fourth, the modular nature of the CEC system allows addition, update, and/or removal of customer service modules and document databases as needed.

In embodiments, it is desirable for the system to update analytics rules in a CAE used by the CEC system to utilize analyze data. This permits the system to adapt to use or non-use of a particular customer service module or document database. In an embodiment, it is desirable to update the analytics rules is based on analysis from either the CAE, another CAE, or a customer service module. In another embodiment, it is desirable to update the analytics rules is based on input from a CEC desktop or a system input. In yet another embodiment, it is desirable to update the customer service modules and/or the document databases along similar lines.

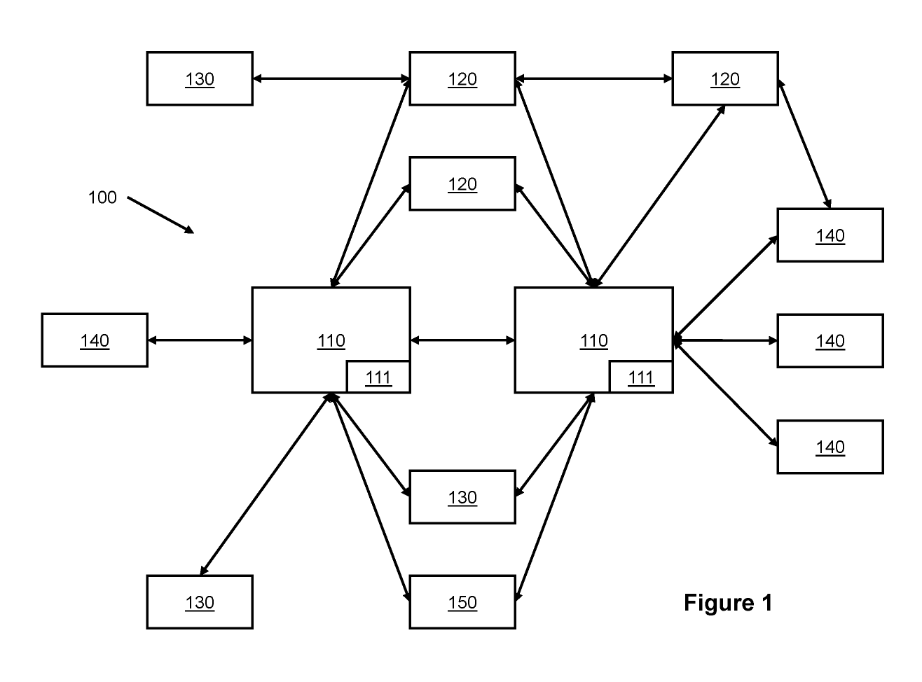

FIG. 1 depicts an exemplary embodiment of CEC system 100 for organizing and integrating electronic customer service resources. CEC system 100 receives and utilizes data from at least one CSR, at least one external contact (by way of non-limiting example, a customer or potential customer), at least one internal contact (by way of non-limiting example, a supervisor or quality assurance (QA) specialist), and/or any combination thereof. CEC system 100 includes at least one CAE 110 connected to at least one customer service module 120 and/or document database 130, at least one CEC desktop 140, and at least one optional system input 150.

CAE 110 is configured to constantly receive and analyze data within CEC system 100. Analysis may be a real-time analysis of streaming data or batch analysis of data. CAE 110 includes at least one set of analytics rules 111 used to analyze data. Analytics rules 111 determine responses to information extracted from data, governing which customer service modules 120 and/or document databases 130 are accessed by CAE 110, and what module functions and/or documents are utilized. Analytics rules 111 may be static or may be dynamically updated by CAE 110, customer service module 120, and/or a user or third party utilizing CEC desktop 140 or system input 150. Updates may be manual or automatic. Automatic updates to analytics rules 111 may be triggered by meeting certain criteria within analytics rules 111 of CAE 110 or within customer service modules 120, or may occur at predetermined intervals. Analytics rules 111 may be software programs or separate files executed by a software program.

While the exemplary embodiment includes two CAEs 110, CEC system 100 may include more CAEs 110 or only one CAE 110. In embodiments with multiple CAEs 110, CAEs 110 may be constantly connected, periodically connected, interconnected through at least one customer service module 120 and/or document database 130, or separate. In embodiments with a single CAE 110, CAE 110 is connected, directly or indirectly, to all customer service modules 120, document databases 130, CEC desktops 140, and/or system inputs 150.

Customer service modules 120 may be connected to CAE 110, other customer service modules 120, document databases 130, and/or CEC desktops 140. In certain embodiments, some customer service modules 120 connect CAE 110 to certain other customer service modules 120 and/or document databases 130. Customer service modules 120 provide different customer service functionalities to CEC system 100. A single customer service module 120 may perform multiple processes, a single process, and/or part of a larger process. In embodiments with multiple CAEs 110, each CAE 110 may have its own set of customer service modules 120 or may share all or some specific customer service modules 120. Customer service modules 120 can be updated by adding, updating, or removing specific customer service modules 120. The connections between CAEs 110, customer service modules 120, document databases 130, and CEC desktops 140 may also be updated.

By way of non-limiting example, customer service modules 120 may perform voice and text analytics, QA analytics, analytics relating to usage of CEC desktop 140 or other available resources, and any other analysis related to a CSR's activities during customer service interactions. Customer service modules 120 may provide the results of such analyses to CAE 110 or to other customer service modules 120. By way of further non-limiting example, customer service modules 120 may also retrieve information for the CSR, such as customer profiles and history, scripts or templates for communication, internal customer service documentation, and any other customer service information. By way of further non-limiting example, customer service modules 120 may also interact with the functions of CEC desktop 140. Such interactions may allow another CEC desktop 140 to observe and/or share another CEC desktop 140, and utilize, update, or transmit or retrieve information to or from certain functions of the CEC desktop 140.

Document databases 130 are connected to CAE 110 and may be connected to other document databases 130 and/or customer service modules 120. Document databases 130 store documents for use by CEC system 100. By way of non-limiting example, document databases 130 may store customer profiles and history, scripts or templates for communication, help screens, forms, internal customer service documentation, routing logs, analysis results, and any other customer service information. Documents stored in document databases 130 may be categorized by type, matter, applicable process, or any other possible classification schema. Document databases 130 and the information contained therein can be updated by adding or removing information to documents in document database(s) 130, adding or removing entire documents to or from document database(s) 130, or adding or removing entire specific document database(s) 130. The connections between CAEs 110, customer service modules 120, and document databases 130 may also be updated.

CEC desktop 140 receives and displays documents from document databases 130 and the results of any analyses from customer service modules 120, if applicable, as relayed by CAE 110. Processes from customer service modules 120 may also interact with the processes of CEC desktop 140. By way of non-limiting example, if a customer service module 120 determines that a CSR on a phone call frequently manually opens a note-taking function on CEC desktop 140, customer service module 120 may automatically open that function when a phone call comes in. Optionally, CEC desktop 140 may also be used to modify analytics rules 111 or submit a request to CAE 110.

System input 150 allows a user to update analytics rules 111. This allows a supervisor, system administrator, or other third party to make changes precisely to analytics rules 111, as opposed to updates which may be caused by usage or made through CEC desktop 140. System input 150 connects to at least one CAE 110.

By way of non-limiting example of the functioning of CEC system 100, if a CSR verbally schedules a follow-up call with a customer, CAE 110 may direct a voice-recognition customer service module 120 to perform voice recognition to determine the date and time for follow-up. Another customer service module 120 utilizes this information to update a calendaring process on CEC desktop 140 with the information. A third customer service module 120 retrieves the customer's contact information from document database 130 for CAE 110 to display on CEC desktop 140 at the scheduled call time. During the call, a fourth customer service module 120 responds to a query received from CEC desktop 140 through CAE 110 by retrieving a specific follow-up script document from document database 130 and displaying it on CEC desktop 140. If, over time, the CSR frequently schedules follow-up calls, CAE 110 may update the analytics rules 111 to automatically connect to an advanced calendaring customer service module 120 during every call. If the CSR stops scheduling follow-up calls, CAE 110 may again update the analytics rules 111 to stop automatically connecting to the advanced calendaring customer service module 120.

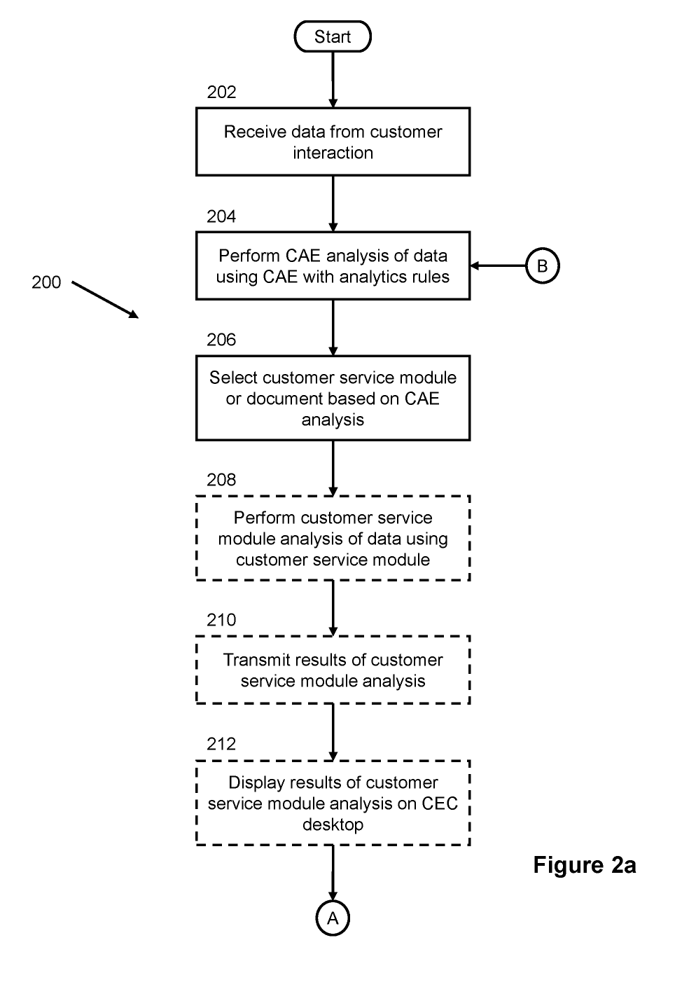

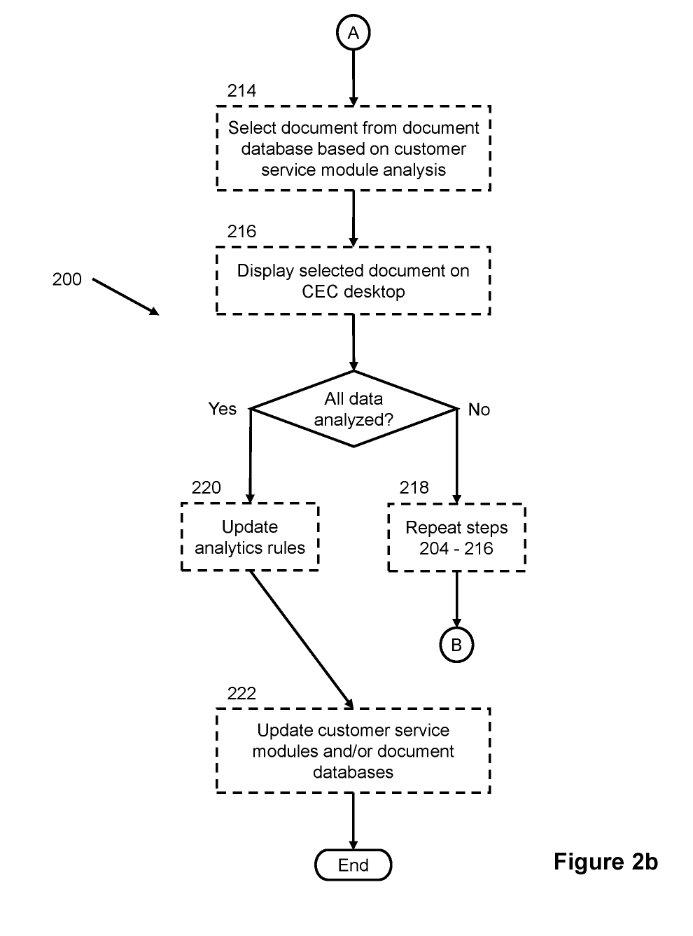

FIGS. 2a and 2b depict a flowchart of an exemplary embodiment of method 200 for organizing and integrating electronic customer service resources using a CEC system.

In step 202, the CEC system receives data from a customer interaction. Such interactions may be multi-sided, such as, but not limited to, a three-way telephone call or an instant message exchange between a CSR and a customer, or one-sided, such as, but not limited to, an email composed by a CSR and addressed to a customer.

In step 204, the CEC system performs CAE analysis of the data using a CAE incorporating a set of analytics rules.

In step 206, the CAE selects at least one customer service module or at least one document from at least one document database based on the CAE analysis of step 204.

In optional step 208, the selected customer service module performs a customer service module analysis of the data.

In optional step 210, the customer service module transmits the results of the customer service module analysis performed in step 208 to the CAE, another customer service module, or the CEC desktop.

In optional step 212, the CAE displays the results of the customer service module analysis performed in step 208 on the CEC desktop.

In optional step 214, the customer service module selects a document from a document database based on the customer service module analysis performed in step 208.

In optional step 216, the CAE displays the selected document on the CEC desktop.

In optional step 218, the CEC system repeats steps 204 through 216, as required, until all data received by the CEC system has been analyzed.

In optional step 220, the CEC system updates the analytics rules based on the CAE analysis from the CAE, another CAE analysis from another CAE, or a customer service module analysis, or based on input from a CEC desktop or a system input.

In optional step 222, the CEC system updates the customer service modules and/or the document databases based on the CAE analysis from the CAE, another CAE analysis from another CAE, or a customer service module analysis, or based on input from a CEC desktop or a system input.

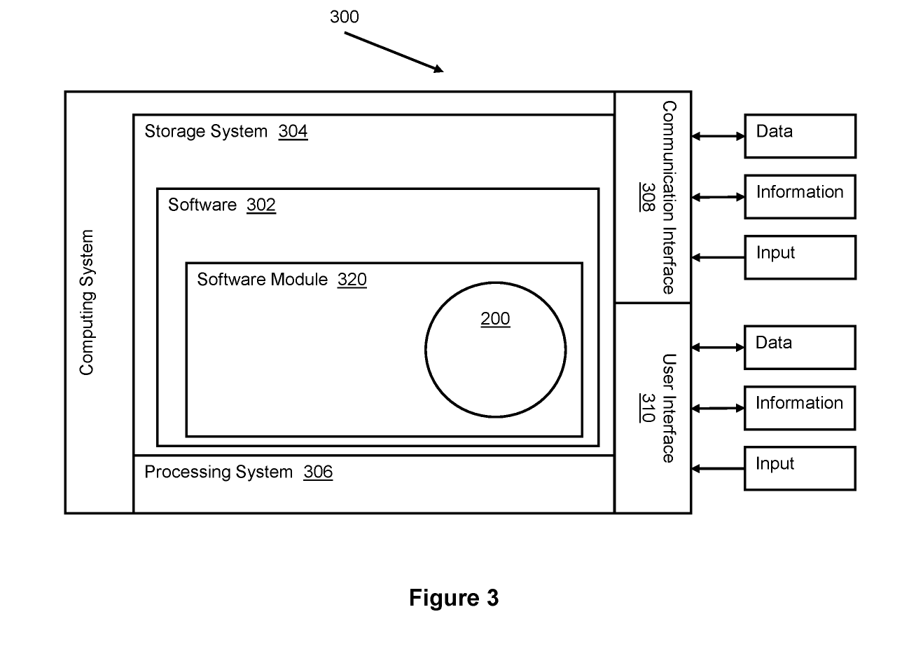

FIG. 3 depicts an exemplary embodiment of system 300 for organizing and integrating electronic customer service resources using a CEC system.

System 300 is generally a computing system that includes a processing system 306, a storage system 304, software 302, a communication interface 308, and a user interface 310. Processing system 306 loads and executes software 302 from the storage system 304, including a software module 320. When executed by computing system 300, software module 320 directs the processing system 306 to operate as described in herein in further detail in accordance with the method 200.

Computing system 300 includes a software module 320 for performing the function of CEC system 100. Although computing system 300 as depicted in FIG. 3 includes one software module 320 in the present example, it should be understood that more modules could provide the same operation. Similarly, while the description as provided herein refers to a computing system 300 and a processing system 306, it is to be recognized that implementations of such systems can be performed using one or more processors, which may be communicatively connected, and such implementations are considered to be within the scope of the description. It is also contemplated that these components of computing system 300 may be operating in a number of physical locations.

The processing system 306 can comprise a microprocessor and other circuitry that retrieves and executes software 302 from storage system 304. Processing system 306 can be implemented within a single processing device but can also be distributed across multiple processing devices or sub-systems that cooperate in existing program instructions. Examples of processing systems 306 include general purpose central processing units, application specific processors, and logic devices, as well as any other type of processing device, combinations of processing devices, or variations thereof.

The storage system 304 can comprise any storage media readable by processing system 306, and capable of storing software 302. The storage system 304 can include volatile and non-volatile, removable and non-removable media implemented in any method or technology for storage of information, such as computer readable instructions, data structures, program modules, or other information. Storage system 304 can be implemented as a single storage device but may also be implemented across multiple storage devices or sub-systems. Storage system 304 can further include additional elements, such a controller capable of communicating with the processing system 306.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to store the desired information and that may be accessed by an instruction execution system, as well as any combination or variation thereof, or any other type of storage medium. In some implementations, the storage media can be a non-transitory storage media. In some implementations, at least a portion of the storage media may be transitory. Storage media may be internal or external to system 300.

As described in further detail herein, computing system 300 receives and transmits data through communication interface 308. The data can include verbal or textual communications to or from a customer and details about a request, a work order, or another set of information that will necessitate an interaction between a customer and the CSR. In embodiments, the communication interface 308 also operates to send and/or receive information, such as, but not limited to, information to/from other modules, devices, and/or systems to which computing system 300 is communicatively connected, and to receive and process system input, as described in greater detail above. Such information can include transmissions between CAE 110 and another CAE 110, customer service module 120, and/or document database 130, documents from document database 130, information about a CSR's use of CEC system 100, and results of analyses performed by CAE 110 or customer service module 120.

User interface 310 can include one or more CEC desktops 140, one or more system inputs 150, a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a video display or graphical display can display documents, CEC desktop 140, or another interface further associated with embodiments of the system and method as disclosed herein. Speakers, printers, haptic devices and other types of output devices may also be included in the user interface 310. A CSR or other staff can communicate with computing system 300 through the user interface 310 in order to view documents, enter or receive data or information, enter system input, manage an interaction, or any number of other tasks the CSR or other staff may want to complete with computing system 300.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. A method for organizing and integrating electronic customer service resources, comprising:
receiving data in a CEC system from a customer interaction;
performing a CAE analysis of the data using a CAE incorporating a set of analytics rules;
selecting at least one customer service module or at least one document from at least one document database based on the CAE analysis; and
repeating, until all data received by the CEC system has been analyzed, performing a CAE analysis of the data using a CAE incorporating a set of analytics rules and selecting at least one customer service module or at least one document from at least one document database.

2. The method of claim 1, further comprising performing a customer service module analysis of the data using the at least one customer service module.

3. The method of claim 2, further comprising transmitting the results of the customer service module analysis to the CAE, another customer service module, or a CEC desktop.

4. The method of claim 2, further comprising displaying the results of the customer service module analysis on a CEC desktop.

5. The method of claim 1, further comprising the at least one customer service module selecting at least one document from at least one document database based on the analysis.

6. The method of claim 5, further comprising displaying the at least one document on a CEC desktop.

7. The method of claim 1, further comprising updating the analytics rules.

8. The method of claim 7, wherein updating the analytics rules is based on the CAE analysis, another CAE analysis from another CAE, or the customer service module analysis.

9. The method of claim 7, wherein updating the analytics rules is based on input from a CEC desktop or a system input.

10. The method of claim 1, further comprising updating the at least one customer service module or the at least one document database.

11. The method of claim 10, wherein updating the at least one customer service module or the at least one document database is based on the CAE analysis, another CAE analysis from another CAE, or the customer service module analysis.

12. The method of claim 10, wherein updating the at least one customer service module or the at least one document database is based on input from a CEC desktop or a system input.

13. A system for organizing and integrating electronic customer service resources, comprising:
a processor; and
a non-transient computer readable medium programmed with computer readable code that upon execution by the processor causes the processor to execute a method for organizing and integrating electronic customer service resources, comprising:
receiving data in a CEC system from a customer interaction;
performing a CAE analysis of the data using a CAE incorporating a set of analytics rules;
selecting at least one customer service module or at least one document from at least one document database based on the CAE analysis; and
repeating, until all data received by the CEC system has been analyzed, performing a CAE analysis of the data using a CAE incorporating a set of analytics rules and selecting at least one customer service module or at least one document from at least one document database.

14. The system of claim 13, wherein the analytics rules are updateable.

15. The system of claim 14, wherein updating the analytics rules is based on analysis from either the CAE, another CAE, or a customer service module.

16. The system of claim 14, wherein updating the analytics rules is based on input from a CEC desktop or a system input.

17. The system of claim 13, wherein the at least one customer service module or the at least one document database is updateable.

18. The system of claim 17, wherein updating the at least one customer service module or the at least one document database is based on analysis from the CAE, another CAE, or a customer service module.

19. The system of claim 17, wherein updating the at least one customer service module or the at least one document database is based on input from a CEC desktop or a system input.

20. A non-transient computer readable medium programmed with computer readable code that upon execution by a processor causes the processor to execute a method for organizing and integrating electronic customer service resources, comprising:
receiving data in a CEC system from a customer interaction;
performing a CAE analysis of the data using a CAE incorporating a set of analytics rules;
selecting at least one customer service module or at least one document from at least one document database based on the CAE analysis; and
repeating, until all data received by the CEC system has been analyzed, performing a CAE analysis of the data using a CAE incorporating a set of analytics rules and selecting at least one customer service module or at least one document from at least one document database.
